(19) United States
(12) Patent Application Publication
(10) Pub. No.: US 2015/0004960 A1
(43) Pub. Date: Jan. 1, 2015

(54) METHOD AND APPARATUS FOR CELLULAR DEVICE IDENTIFICATION

(71) Applicant: L3 Communications-ASIT, Linthicum Heights, MD (US)

(72) Inventor: James D. Haverty, Meredith, NH (US)

(21) Appl. No.: 14/319,131

(22) Filed: Jun. 30, 2014

Related U.S. Application Data
(60) Provisional application No. 61/840,808, filed on Jun. 28, 2013.
(60) Provisional application No. 61/846,768, filed on Jul. 16, 2013.

(51) Int. Cl. H04W 8/22; H04W 4/02

(52) U.S. Cl. CPC H04W 8/22; H04W 4/02
USPC 455/419

(57) ABSTRACT

A system monitors cellular device usage within a use-prohibited area, and either passively detects or actively elicits identity events related to a cellular device within the use-prohibited area and provides the identifying events and any identifying information therein, along with temporal and locational information, to a service provider to determine the identity of the cellular device. Such information can then be used by the service provider to disable service to the cellular device.

### CROSS-REFERENCE TO RELATED APPLICATION

This application claims priority under 35 U.S.C. §119 to U.S. provisional application 61/840,808, entitled METHOD AND APPARATUS FOR DERIVING PERMANENT CELL IDENTIFIER INFORMATION FROM TEMPORARY IDENTIFICATION INFORMATION, filed on Jun. 28, 2013 and U.S. provisional patent application 61/846,768, entitled METHOD AND APPARATUS FOR DERIVING PERMANENT CELL IDENTIFIER INFORMATION FROM TEMPORARY IDENTIFICATION INFORMATION, filed on Jul. 16, 2013, the disclosure of each of which is hereby incorporated by reference in its entirety.

### TECHNICAL FIELD

The inventive concepts relate generally to the field of cellular communications, and more particularly to systems, devices, and method used to determine the identification of a cellular device.

### DISCUSSION OF RELATED ART

Although extremely convenient, cellular devices, which may include telephones, smartphones, or tablet computers, as examples, may be used at times and places where their use poses an inconvenience, if not an outright hazard, for those surrounding the user and, possibly, for society at large. Despite the common knowledge that telephone usage may be disruptive in a public setting, at a concert, at a movie, in a court room, or other such event, many people persist in using telephones in those settings. Generally, such occurrences amount to nothing more than an inconvenience or annoyance.

Other instances of illicit cellular use, however, can present a real threat, far beyond the minor inconvenience of a distracting conversation. Use of cellular devices is generally prohibited in road construction zones and in areas where blasting is taking place. Those who violate these prohibitions pose a danger to themselves and to others. In other settings, such as jails, detention centers, prisons, or other incarceration units, the use of cellular devices is strictly prohibited in order to protect the public at large and those who work within such facilities.

Because prohibitions against cellular use are widely ignored, and their use in prohibited areas, such as incarceration units, poses a real danger to society, a method and apparatus for identifying and disabling or otherwise dealing with illicitly-employed cellular devices would be desirable.

Cellular standards make use of the notion of a temporary identifier, generally known in the art as a temporary mobile subscriber identifier (TMSI). The purpose of the TMSI is to disguise the identity of a particular subscriber from a prying third party receiver by substituting a temporary identifier, which changes regularly, for a permanent identifier. Except for an initial registration, typically associated with power on, which in general uses a permanent (unique) identifier, subsequent interactions, such as paging or origination, between the cell phone and the network use TMSIs. At the initial registration the network will dole out a temporary identifier and will then regularly update this identifier at its discretion.

Frick et. al., Method for identifying a mobile phone user or for eavesdropping on outgoing calls European Patent EP1051053, which is hereby incorporated by reference, describes a third party transceiver known in the art as an interrogator that is able to masquerade as a legitimate network beacon and entice a cell phone to register in some operational area and thereafter be queried for permanent identifying information. This information can be passed to a service provider which can in turn elect to disable service if it is determined the device is operating in a prohibited area such as an incarceration facility.

This method has two important shortcomings. First it requires an active transceiver that may interfere with the normal operations of the cellular network, albeit temporally and locally, which nonetheless has the potential to contravene regulations such as the US 1934 Communications Act. Second it requires that permanent identifiers be collected and transmitted through third parties thus raising the potential for privacy concerns.

### SUMMARY

In exemplary embodiments in accordance with principles of inventive concepts, a method includes a processor receiving identifying events related to a cellular device; the processor combining locational or network information with the time of the event of the event and optionally explicit identity information; and the processor providing said to a service provider in order for the service provider to disambiguate or otherwise identify the device.

In various embodiments, the method can include the processor providing temporal information to the service provider to identify the device.

In various embodiments, the locational information can be one or more types of information from a group including: the location of a serving cell, the location of a collection transceiver, the location of a cellular device, the identifier of a serving cell, and a proxy identifier that represents a registration area.

In various embodiments, the identity information can include temporal information that is or includes a timestamp correlated with a time at which the processor receives the express (albeit temporal) identity information related to the cellular device. It can also include implied information such as the serving cell identifier coupled with a timestamp when an event that is associated with an exchange of identity information, such as registration or origination, is detected. Either can be supplemented with other ancillary information such as the network location area.

In various embodiments, the method can include a processor receiving identity information from a collection transceiver that monitors cellular device activity within a use-prohibited area.

In various embodiments, the method can include a collection transceiver passively collecting cellular identification events and/or the explicit identity information carried therein.

In various embodiments, the method can include a collection transceiver actively collecting cellular device identity information.

In various embodiments, the method can include identity information that is a temporary identifier assigned to the device by a cellular network associated with a cellular registration area.

In various embodiments, the method can include a processor causing service to the identified cellular device be disabled.

In exemplary embodiments in accordance with principles of inventive concepts, a method of controlling cellular device operation within a use-prohibited area includes a baiting beacon within the use-prohibited area capturing identity information from a cellular device; a transceiver associated with the baiting beacon providing the identity information to a processor; the processor combining locational information with the identity information; and the processor providing identity and locational information related to the cellular device to a service provider in order for the service provider to identify the device.

In various embodiments, the method can include a baiting beacon inducing a cellular device to provide identity information.

In exemplary embodiments in accordance with principles of inventive concepts, a system includes a processor to receive identity information related to a cellular device; the processor is configured to combine locational information with the identity information; and the processor is configured to provide identity and locational information related to the cellular device to a service provider in order for the service provider to identify the device.

In various embodiments, the processor can be configured to provide temporal information or other information that implies a particular device or subscriber to the service provider so as to disambiguate the identity of the device and by implication the subscriber.

In various embodiments, the locational information can be from of a group, including one or more of: a location of a serving cell, a location of a collection transceiver, a location of a cellular device, an identifier of a serving cell, and a proxy identifier that represents a registration area.

In various embodiments, the identity information can include temporal information that is or includes a timestamp correlated with the time at which the processor receives identity information or otherwise detects an identifying event related to a cellular device.

In various embodiments, the processor can be configured to receive the identity information from a collection transceiver that monitors cellular device activity within a use-prohibited area.

In various embodiments, a unique channel expression can be formulated that can include channel allocation information such as, for example, the frequency channel or channel set; frequency hopping sequence; training sequence; time slot; code channel; or any combinations thereof on which signaling was detected in proximity in addition to temporal information that is or includes a timestamp correlated with the time at which the processor analyzes signaling identity information associated with a particular cellular device as well as location information such as the cell id and location area if the cell id is not sufficiently unique.

In various embodiments noted above, the processor can be a single processor or a plurality of processors.

### BRIEF DESCRIPTION OF THE DRAWINGS

The foregoing and other features and advantages of inventive concepts will be apparent from the more particular description of exemplary embodiments in accordance with principles of inventive concepts, as illustrated in the accompanying drawings in which like reference characters refer to the same parts throughout the different views. The drawings are not necessarily to scale, emphasis instead being placed upon illustrating the principles of inventive concepts. In the drawings:

FIG. 1 is a schematic illustration of an exemplary embodiment of a system configured to identify cellular devices, in accordance with principles of inventive concepts as it relates to an environment of interest;

FIG. 2 is a flow chart depicting an exemplary embodiment of a cellular device identification process, e.g., such as may be employed by a system of FIG. 1, in accordance with principles of inventive concepts.

### DETAILED DESCRIPTION

Various exemplary embodiments will be described more fully hereinafter with reference to the accompanying drawings, in which exemplary embodiments are shown. The inventive concepts may, however, be embodied in many different forms and should not be construed as limited to exemplary embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, and/or devices, these elements, components, and/or devices should not be limited by these terms. These terms are only used to distinguish one element, component, or device from another. In this manner, a first element, component, or device discussed below could be termed a second element, component, or device without departing from the teachings of inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, as examples, but do not preclude the presence or addition of one or more other features, integers, steps, operations, elements, components, and/or groups thereof.

Exemplary embodiments are described herein with reference to illustrations that are schematic illustrations of idealized exemplary embodiments (and intermediate structures). As such, variations from the shapes of the illustrations are to be expected. In this manner, exemplary embodiments should not be construed as limited to the particular shapes illustrated herein, but are to include deviations in shapes.

Processes may be described as including steps that proceed in a certain order, but inventive concepts are not limited thereto, unless indicated. Other sequences of steps, substitution or deletion of steps, or other processes are contemplated within the scope of inventive concepts.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The methods described herein describe the means for circumventing shortcomings of conventional approaches by either explicitly collecting temporary identifiers in lieu of permanent identifiers (whether through active or passive means) or by forgoing collection of identifying information altogether and, instead, passively logging all identifying events that have occurred in some proximity to the either an active transceiver or a passive receiver respectively. Identifying events may be detected through signaling activity that may be associated with an identifying event (a cellular device signals a serving cell during registration, for example), or a channel expression analysis (a cellular device enters into the traffic state and operates on a temporally unique channel, for example), for example. This information when properly framed within the context of time and/or space would then be sufficient for a service provider to disambiguate an individual subscriber, whether associated with specific user equipment or a subscriber identity module used thereby, and subsequently target the associated devices, or some subscriber account in general, for action.

In exemplary embodiments, a system and method in accordance with principles of inventive concepts may employ either an explicit temporary identifier associated with a cellular device or an implicit identifier derived from an identifying event that includes, for example, an environmental context such as the time of the identifying event and the serving cell in which the event occurred to subsequently disambiguate the unique and permanent identity of the device.

The same system and method can further bypass direct identity or identifying event collection and be used to extract the unique channel expression of uplink traffic of some cellular device that is operating in proximity to the system which is again tagged with temporal and locational information. An important benefit is the potential for saving significant receiver resources and attendant cost as the receiver does not need to camp on each potential channel awaiting an asynchronous identifying event. Instead it can time division multiplex the receiver across multiple channels so as detect energy from the uplink traffic occurring in proximity and then dwell only long enough to determine a channel expression. This information may then be used, for example, in cooperation with a service provider to disable the device. As will be described in greater detail below, a system and method in accordance with principles of inventive concepts may employ passive or active approaches to determine a device's identity.

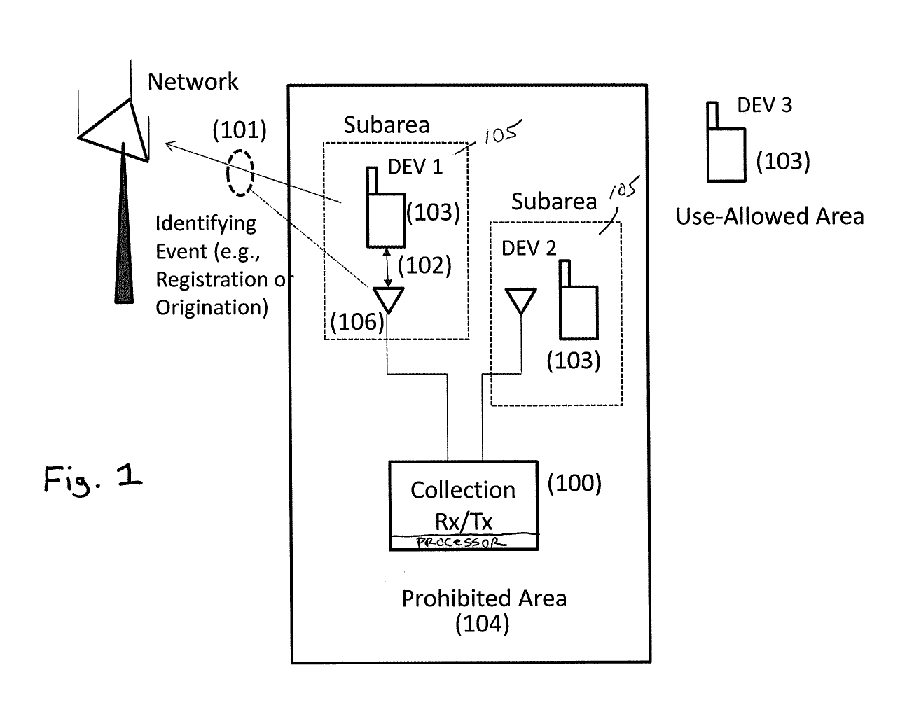

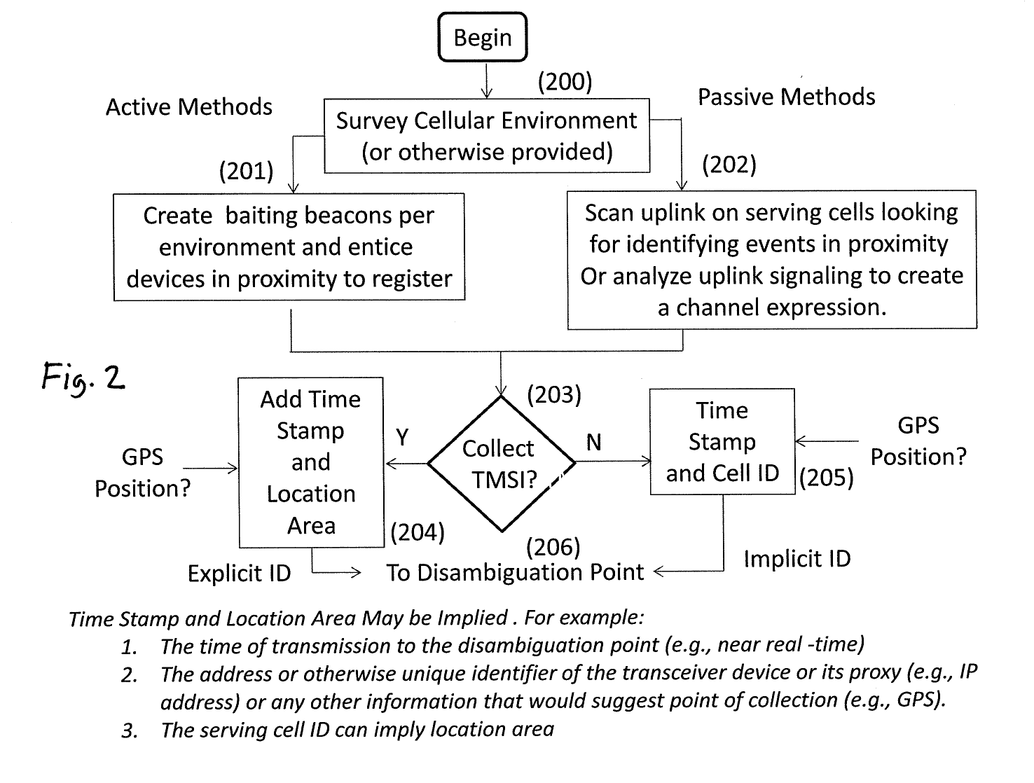

FIG. 1 is a schematic illustration of an exemplary embodiment of a system 100 in accordance with principles of inventive concepts as it relates to an environment of interest, e.g., a restricted-use area. FIG. 2 is a flow chart depicting an exemplary embodiment of a process such as may be employed by a system 100 in accordance with principles of inventive concepts.

Turning to FIG. 1, a cellular detection and identification system 100 in accordance with principles of inventive concepts is configured to either passively collect all identifying events (101) or actively elicit a registration response (102) from cellular devices (103) that are operating within some distance of an antenna, with possible angular restrictions. A cellular device DEV1, DEV2 or DEV3 (103), may be a cellular telephone, cellular smartphone, cellular tablet, or a cellular watch: in short, any device that may employ a cellular communications system for voice, text, or data communications.

The detection and identification system (100) may employ one or more spatially diverse antennas that are distributed throughout some use-prohibited area (104). The antennas may be distributed, tuned, attenuated, directionalized, or otherwise adjusted to limit the effect of any active methods to subareas in (105). The radius of effect is limited to the subareas (105) by moderating the effective radiated power of the signal emitted at the antenna (106) by any number of means including, but not limited to, analog attenuation applied at the antenna, choice of antenna directionality, software control of the individual active signals that are matched to those mimicked in the environment.

The same configuration can be used for passive detection, with receiver sensitivity adjusted so that only cellular devices operating in proximity are detected or otherwise inventoried. Similar techniques for adjusting the receiver sensitivity described for the active case are again applicable here, as well as simply establishing a received signal strength indicator (RSSI) threshold associated with a processor in system 100, which is used to determine whether a cellular device as detected by its associated identifying events or traffic signaling is operating within sufficient proximity.

As will be described in greater detail in the discussion related to FIG. 2 a cellular identification system 100 in accordance with principles of inventive concepts may employ an active or passive process to either explicitly or implicitly identify cellular devices that are determined to be operating within a prohibited-use area, such as area 104 (or 105 therein) of FIG. 1.

The flow chart of FIG. 2 depicts an exemplary embodiment of a process in accordance with principles of inventive concepts in which a system 100 either explicitly or implicitly collects information sufficient to disambiguate the permanent identifiers of a cellular device, such as may be operating within a use-prohibited area 104. Such information may include any one or any combination of: permanent or temporary identification information, temporal information, or spatial information, or channel of operation for example. Additionally, in accordance with principles of inventive concepts, such information may be obtained actively, passively, or through a combination of such approaches. The acquisition of such information occurs electromagnetically over the air interface of cellular network using electronic means, in this embodiment.

System 100 may either scan the local environment or it is otherwise supplied information by either third party equipment or services including but not limited to the cellular service provider. After acquiring identification information in step 200, the process proceeds next based on whether active or passive means are employed.

In the active case 201, the system 100 creates a set of baiting beacons whether in parallel or tandem that entice devices that are in proximity to register and thereby proffer explicit identifying information including the TMSI.

In the strictly passive mode of operation 202 the system 100 uses the environmental information to determine how to monitor the uplink signaling emitted by the cellular devices operating in the prohibited area 104 or subarea 105 therein. More specifically it uses the environmental information such as the beacon parameters in the live network operating in the local area and determines how to deploy receivers that will look for signaling on either the up or downlinks between a base station and a cellular device that contains identifying events such as registration, origination or answer to page. That is, in exemplary embodiments in accordance with principles of inventive concepts, a system may monitor signaling between cellular device(s) and base station(s) for activity. Because signaling activity may be associated with an identifying event (a cellular device signals a serving cell during registration, for example), or a channel expression analysis (a cellular device enters into the traffic state and operates on a temporally unique channel, for example) a system and method in accordance with principles of inventive concepts may detect signaling events and correlate those events, using associated temporal and spatial information, to identify the cellular device. As indicated below, the time, channel and location of the signaling event may be correlated with buffered information (for example, information buffered from a downlink) to obtain, at a disambiguation point, the identity of the cellular device.

It is further anticipated by the methods described herein that it is possible to disambiguate a subscriber merely by analyzing the signaling used to convey traffic (either voice or data). Haverty U.S. Pat. No. 8,606,171 Methods of suppressing GSM wireless device threats in dynamic or wide area static environments using minimal power consumption and collateral interference; and Haverty U.S. Pat. No. 8,526,395 Using code channel overrides to suppress CDMA wireless devices, teach methods for analyzing signaling in the traffic phase between the cellular device and the network for the GSM and CDMA standards with similar notions apply to the UMTS and LTE standards. More generally, a subscriber is necessarily allocated a temporally unique “channel” where channel is taken to mean any unique combination of time, frequency, code multiplexed or any combination thereof or process therein such as employing a frequency hopping set, which prevents or otherwise minimize cross subscriber interference. This uniqueness, when qualified with a proximity indication to the receivers, described in the foregoing, along with a time stamp and locational information provide yet another avenue for a service provider to disambiguate a subscriber without the benefit of or the requirement to capture any identifying events or explicit identifiers, whether temporary or permanent. Haverty U.S. Pat. No. 8,606,171 and Haverty U.S. Pat. No. 8,526,395, describe methods for analyzing the uplinks for the GSM and CDMA standards so as to derive a channel expression individually for each device operating in proximity. In the LTE standard the same may be achieved by analyzing the subscriber specific radio network temporary identifier (RNTI) that can be intercepted from the Physical Downlink Control Channel which also conveys the temporal channels of operation for each specific device. In this case, the intercepted downlink control messages that contain a RNTI and frequency or time allocation (the channel information) can be matched against uplink energy patterns detected in proximity and either the associated RNTI or the channel expressions themselves may be reported to the disambiguation point.

It can be the case that the system would listen to all downlink information on a particular beacon and store this information in a buffer and when there is uplink energy detection or even more specifically protocol signaling detected in proximity then tag the downlink events or identifiers therein as being related to some high proximity signaling and thereby tag those buffered events as being directed to some cellular device operating in proximity. Alternately or in combination or otherwise in conjunction with downlink monitoring, it can also be the case the receiver listens on the uplink directly for identifying events occurring in proximity and tags those events with a cell id and a time stamp.

In either case, if it is determined 203 that collection of TMSI information is collected, the information is nominally stamped with information necessary to disambiguate the TMSI which includes the time at which the identifying event took place and the location area (or some equivalent) in which it took place 204.

In the event that TMSI is not collected, the identity event or channel expression is stamped with the serving cell ID and any other necessary disambiguating information such as the location area 205 if for example the cell ID is not unique across the entire network of some service provider.

The collected information may be recorded and then presented to the appropriate disambiguation point (206), based on the mobile country and network codes (or equivalents) as collected or otherwise provided in the environmental information 200.

The information can be conveyed to a disambiguation point 206 by any number of means such as direct electronic connection, paper lists or even verbally. In some cases time stamps or location areas can be implied or otherwise derived. For example the identifying events might be conveyed in at or near real-time and therefore the timestamp becomes the time a record is received by the disambiguation point rather than an explicit time stamp. Similarly the location area might be implied by a cell id or an IP address from which the record was received.

A disambiguation point is nominally the service provider or any third party that is capable of taking the provided information and from it determine the permanent identifiers associated with the identifying information collected at a particular time and/or place.

An exemplary embodiment of the system in 100 may employ a software defined radio (SDR) that is hosted by a single board computer in an integrated chassis. The SDR is capable of either actively mimicking a live cellular network to the degree necessary to entice a cellular device to register with it or can passively monitor either the uplink or downlink traffic of the live cellular environment. The single board computer provides all of the external interfaces including IP connectivity through which the system can convey the information either directly to a disambiguation point or indirectly to some other medium.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

1-24. (canceled)

25. A cellular device identifying method, comprising:
a processor receiving identity information related to a cellular device;
the processor combining locational information with the identity information; and
the processor providing identity and locational information related to the cellular device to a service provider in order for the service provider to identify the cellular device.

26. The method of claim 25, further comprising:
the processor providing temporal information to the service provider to identify the device.

27. The method of claim 25, wherein the locational information is one or more types of information from a group, including: a location of a serving cell, a location of a collection transceiver, a location of a cellular device, an identifier of a serving cell, and a proxy identifier that represents a registration area.

28. The method of claim 26, wherein the temporal information includes a timestamp correlated with a time at which the processor receives the identity information related to the cellular device.

29. The method of claim 25, further comprising the processor receiving the identity information from a collection transceiver that monitors cellular device activity within a use-prohibited area.

30. The method of claim 29, further comprising the collection transceiver passively collecting cellular device identity information.

31. The method of claim 29, further comprising the collection transceiver actively collecting the identity information related to the cellular device.

32. The method of claim 29, wherein the identity information is a temporary identifier assigned to the cellular device by a cellular network associated with a cellular registration area.

33. The method of claim 25, further comprising the service provider disabling service to the identified cellular device.

34. A method of controlling cellular device operation within a use-prohibited area, comprising:
a baiting beacon within the use-prohibited area capturing identity information from a cellular device;
a transceiver associated with the baiting beacon providing the identity information to a processor;
the processor combining locational information with the identity information; and
the processor providing identity and locational information related to the cellular device to a service provider in order for the service provider to identify the device.

35. The method of claim 34, including the baiting beacon inducing the cellular device to provide identity information.

36. A system configured to control cellular device operation within a use-prohibited area, the system comprising:
a processor configured to receive identity information related to a cellular device;
the processor configured to combine locational information with the identity information; and
the processor configured to provide identity and locational information related to the cellular device to a service provider in order for the service provider to identify the device.

37. The system of claim 36, wherein the processor is configured to provide temporal information to the service provider to identify the device.

38. The system of claim 36, wherein the locational information is one or more types of information from of a group including: a location of a serving cell, a location of a collection transceiver, a location of a cellular device, an identifier of a serving cell, and a proxy identifier that represent a registration area.

39. The system of claim 37, wherein the temporal information includes a timestamp correlated with the time at which the processor receives identity information related to the cellular device.

40. The system of claim 36, further comprising a collection transceiver configured to monitor cellular device activity within a use-prohibited area and to communicate the identity information from to the processor.

41. The system of claim 40, wherein the collection transceiver is configured to passively collect cellular device identity information.

42. The system of claim 40, wherein the collection transceiver is configured to actively collect cellular device identity information.

41. The system of claim 38, wherein the identity information is a temporary identifier assigned to the device by a cellular network associated with a cellular registration area.

42. The system of claim 34, further comprising a service provider system configured to disable cellular service to the identified device in response to the identity and locational information related to the cellular device provided by the processor.

43. A cellular identification method that comprises the steps of analyzing the cellular environment, detecting signaling in proximity to the system, analyzing the signaling to create an unique expression for the channel in use and tagging the expression with temporal or locational information and providing this information to a disambiguation point for subsequent action.

44. The method of claim 43, further comprising of collecting the PDCCH information on the LTE downlink, extracting the RNTI and associated channel allocation from the control signaling, analyzing the associated uplink signaling to match it to the channel allocation and reporting the RNTI or equivalently the channel expression to the disambiguation point.
